(19) United States
(12) Patent Application Publication
(10) Pub. No.: US 2020/0037053 A1
(43) Pub. Date: Jan. 30, 2020

(54) Low Power Remote Monitoring System With Pyroelectric Infrared Sensor And False Detect Discriminator

(71) Applicant: IoT Networks, Inc., Colorado Springs, CO (US)

(72) Inventor: Jess E. Cobb, Lafayette, CO (US)

(73) Assignee: IoT Networks, Inc., Colorado Springs, CO (US)

(21) Appl. No.: 16/517,108

(22) Filed: Jul. 19, 2019

Related U.S. Application Data
(60) Provisional application No. 62/711,404, filed on Jul. 27, 2018.

(51) Int. Cl. H04Q 9/00; G01J 5/34; G05B 19/042

(52) U.S. Cl. CPC H04Q 9/00; H04W 84/18; G05B 19/042; G01J 5/34

(57) ABSTRACT

A low power, remote monitoring system includes a hub with a real time clock (RTC) generating an RTC signal after a dwell time; a first power gating circuit generating a first power-on signal; and a first baseband and communication block activating on receiving the first power-on signal, sending a cry-out poll to a sensor for event detection data, and specifying the dwell time at the RTC. The sensor system includes a sensing circuit generating a sensing signal when an event is detected; a discriminator logic for generating a valid motion signal if the event is validated; a second power gating circuit generating a power-on signal; and a second baseband and communication block activating when the power-on signal is received, generating an event detection signal, and transmitting the event detection signal when the cry-out poll is received. First and second baseband and communication blocks are powered down when not in use.

### FIELD OF THE INVENTION

The present invention relates to remote monitoring systems and, more particularly, to low power remote monitoring system including sensors and logic circuitry.

### BACKGROUND OF THE INVENTION

Remote monitoring systems are used, for example, in motion detection and security applications. While a variety of low power configurations are available, most require a plug-in connection to a power source, such as a household AC outlet. Many such low power remote monitoring systems are based on low power sensors, such as proximity sensors and pyroelectric infrared (PIR) sensors. While relatively inexpensive and low power, most systems based on such sensors do still require a plug-in to an outlet or a change of battery every few months (see, for example, “PIR MOTION DETECTOR WITH ARDUINO: OPERATED AT LOWEST POWER CONSUMPTION MODE” (accessed Apr. 23, 2018, http://www.instructables.com/id/PIR-Motion-Detector-With-Arduino-Operated-at-Lowes/). While certain security applications utilize PIR sensors that run on batteries over a year or two, their usage is severely constrained by firmware such that, for example, they are unresponsive to events after an initial event has occurred for periods of 3 to 15 minutes, in order to conserve battery power.

### SUMMARY OF THE INVENTION

In accordance with the embodiments described herein, a low power, remote monitoring system includes a hub system in communication with a sensor system. The hub system includes a real time clock [RTC] for generating an RTC signal upon passage of a preset dwell time. The hub system also includes a first power gating circuit for generating a first power-on signal in response to receiving the RTC signal. The hub also includes a first baseband and communication block configured for activating when the first power-on signal is received. When the first baseband and communication block is activated, it sends out a cry-out poll to the sensor system for data related to an event detection. Once data has been received from the sensor system, the first baseband and communication block specifies the preset dwell time at the real time clock, then sends out a first power-down signal to the first power gating circuit. The sensor system includes a sensing circuit for generating a sensing signal when an event is detected, and a discriminator logic circuit for receiving the sensing signal, validating the sensing signal, and generating a valid motion signal only if the sensing signal corresponds to a validated event. The sensor system also includes a second power gating circuit for generating a power-on signal in response to the valid motion signal received from the discriminator logic circuit. The sensor system further includes a second baseband and communication block configured for activating when the power-on signal is received from the second power management circuit, generating an event detection signal as data related to the event detection, transmitting the event detection signal to the hub system when the cry-out poll is received, and sending a second power-down signal to the second power gating circuit, once the event detection signal has been transmitted to the hub system. The first and second power gating circuits are configured to power down the first and second baseband and communication blocks upon receipt of the first and second power-down signals, respectively.

In another embodiment, the hub system of the low power, remote monitoring system further includes a first wake-up timer for generating a first wake-up signal at preset time intervals, wherein the first power gating circuit is configured for generating the first power-on signal in response to one of the valid motion signal and the first wake-up signal.

In still another embodiment, the preset time interval is longer than the preset dwell time.

In yet another embodiment, the sensor system of the low power, remote monitoring system further includes a second wake-up timer for generating wake-up signals at preset time intervals, and the second power gating circuit is configured for generating the second power-on signal in response to one of the RTC signal and the second wake-up signal.

In a further embodiment, the sensor system of the low power, remote monitoring system is configured for providing a system status signal rather than the event detection signal, if no validated event had occurred when the cry-out poll is received.

### BRIEF DESCRIPTION OF THE DRAWINGS

FIG. 1 shows a remote monitoring system, in accordance with an embodiment.

FIG. 2 shows a schematic diagram of a false detect discriminator circuit for use with a remote monitoring system, in accordance with an embodiment.

FIG. 3 shows a schematic diagram of a dual-stage timer circuit for use as a hub for use with a remote monitoring system, in accordance with an embodiment.

FIG. 4 shows a flow chart illustrating a false detect discrimination process, in accordance with an embodiment.

FIG. 5 is a flow chart illustrating a process at a hub for receiving data from one or more sensor systems.

FIG. 6 is a diagram of an exemplary remote monitoring system, including multiple sensors and a wireless hub, in accordance with an embodiment.

FIG. 7 is a flow chart illustrating an enhanced false detect discrimination process, in accordance with an embodiment.

### DETAILED DESCRIPTION OF EMBODIMENTS OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items, and may be abbreviated as “/”.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present. Likewise, when light is received or provided “from” one element, it can be received or provided directly from that element or from an intervening element. On the other hand, when light is received or provided “directly from” one element, there are no intervening elements present.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Accordingly, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

It would be desirable to have a remote monitoring system with extremely low power consumption such that the system can be operated for several months to several years on a single set of commercial batteries. Additionally, it would be desirable for the remote monitoring system to include advanced features, such as logic and circuitry to reduce false detection from sensor noise and internally generated noise during power gating. Furthermore, it would be desirable for the remote monitoring system to be able to transmit and receive data in an efficient, low data and power consumption way.

The remote monitoring system described herein provides an innovative combination of low power control features and advanced processing features to enable battery operation of the system for several years on a single set of commercial batteries. The system further includes false detect discriminator logic circuit to minimize the number of false event detection. Furthermore, the system includes secure data transmission and reception capabilities, including low data transmission rates and encryption.

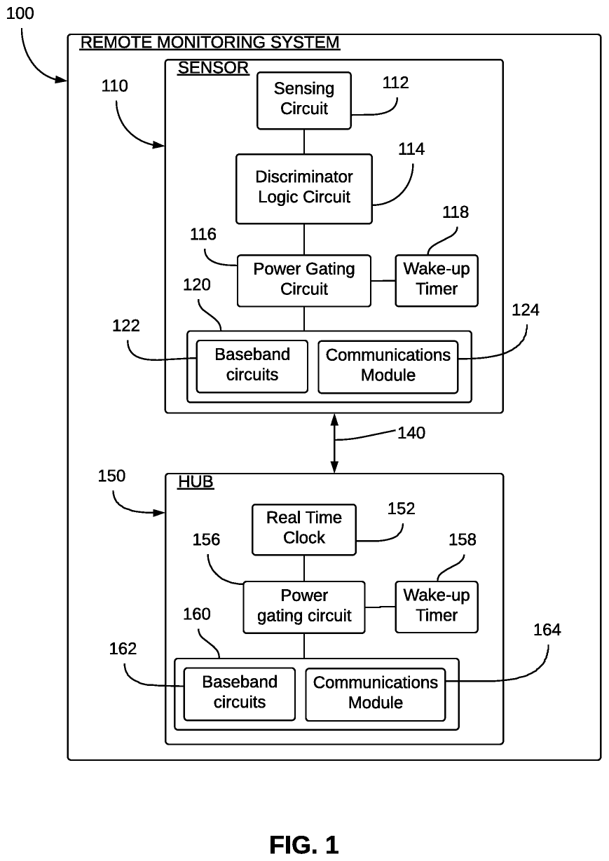

An exemplary remote monitoring system is shown in FIG. 1. A remote monitoring system 100 includes a sensor system 110, which includes a sensing circuit 110 (such as a pyroelectric infrared (PIR) sensor) connected with a discriminator logic circuit 114. Sensor system 110 also includes a first power gating circuit 116, which is configured to cooperate with discriminator logic circuit 114 and an optional, first wakeup timer 118 for providing power to a first baseband and communication block 120 according to the analysis performed by discriminator logic circuit 114. First wakeup timer 118 optionally provides periodic signal to activate first power gating circuit 116 on a preset schedule such that first baseband and communication block 120 transmits a regular set of status information, such as the ambient temperature, error logs, and battery status, as a “health check” or periodic data logging of sensor system 110. First baseband and communication block 120 includes first baseband circuits 122, such as a processor, memory, ancillary sensors, and analog/digital (A/D) converter. Also included in first baseband and communication block 120 is a first communications module 124, which includes a wireless modem (e.g., a wireless sensor network modem) and/or other mechanisms for communicating with external devices.

In an embodiment, when sensing circuit 110 provides a signal to discriminator logic circuit 114 to indicate an event (e.g., motion detection) has been detected at sensing circuit 112, discriminator logic circuit 114 performs an analysis to determine whether the signal corresponds to a valid motion signal. For example, first power gating circuit 116 is configured to only provide power to first baseband and communication block 120 upon receipt of a valid motion signal from discriminator logic circuit 114, so as to reduce the instance of false detection being recorded at baseband circuits 122, thus saving energy. Additionally, first power gating circuit 116 is activated at preset intervals by first wakeup timer 118 so as to provide regular reporting of status information related to sensor system 110, thus reassuring the user that sensor system 110 is operating normally even if no event is detected.

Continuing to refer to FIG. 1, remote monitoring system 100 further includes a hub 150, which includes a real time clock (RTC) 152 connected with a second power gating circuit 156, which is also connected with a second wakeup timer 158. Second power gating circuit 156 is configured for controlling the power status of a second baseband and communication block 160 such that second baseband and communication block 160 is powered on only when second power gating circuit receives an appropriate signal from real time clock 152 or second wakeup timer 158. Second baseband and communication block 160 includes second baseband circuits 162 and a second communications module 164. Second baseband circuits 162 includes, for instance, a processor, memory, ancillary sensors, and/or an A/D converter. Second communications module 164 can include a variety of mechanisms for connecting with external devices, such as sensor 110, a personal mobile communication device, and/or a remote computer. For instance, second communications module 164 can include a wireless modem (e.g., a wireless sensor network modem for communicating with the wireless modem at sensor system 110), backhaul modem circuits, Bluetooth circuits, and/or cellular communication circuits. Sensor system 110 can communicated wirelessly or via physical connection with hub 150 using first communication module 124 and second communication module 164.

While remote monitoring system 100 can be used with a PIR sensor, other types of sensors can be used as well, as will be discussed at an appropriate juncture below. The combination of the circuitry, firmware, and software of remote monitoring system 100 allows extremely low power operation while enabling advanced logic communication characteristics. In other words, remote monitoring system 100 provides an innovative combination of advanced detection features, low power operation, and efficient data transmission and reception to enable heretofore impossible battery-operated applications.

Remote monitoring system 100 can be optimized, for example, for pest detection in indoor areas (e.g., within cabinets, basements, parking structures, or other dark, closed areas) by, for example, tailoring the detection sensitivity of PIR sensor 110 (or alternative sensors) for rodent and small mammal detection in areas out of sunlight with low activity. Alternatively, remote monitoring system 100 would be useful, with the appropriate sensors, in applications such as pest detection in recreational vehicles (RVs), boats, residential and vacation homes, and commercial buildings, rodent trap occupancy detection, asset tracking at construction sites, providing telematics at oil and gas sites, agricultural technologies, transportation and logistics, and other Internet of Things (IoT) applications such as rodent detection, tire pressure monitoring of RVs in storage, and remote control of appliances such as refrigerators, heaters, rodent traps, and generators. Alternative or ancillary sensors, such as one or more of the following, are applicable for use as sensors in remote monitoring system 100:

A) Infrared sensor;

B) Rodent & small mammal trap detector (e.g., motion and vibration detector);

C) Rodent trap detector (e.g., for detecting electric pulses from electric traps);

D) Water or humidity sensor (i.e., for detect the presence of water);

E) Temperature sensor;

F) Tire pressure sensor (e.g., for use with RVs, truck fleets, and other vehicles and aircraft);

G) Accelerometer detection (i.e., for detection of movements, large and small);

H) Light level sensor;

I) Microphonics sensor;

J) Pressure sensor;

K) Fluid flow sensor;

L) Fluid pressure sensor;

M) Airflow sensor;

N) Oil tank sensor;

O) Oil field detection sensor;

P) Oxygen sensor;

Q) Air quality sensors;

R) Motor defect sensor (e.g., for sensing undesired vibration)

S) Hall effect sensor;

T) Dew sensor;

U) Gas detector;

V) Rain sensor;

W) Lighting sensor;

X) Smoke sensor;

Y) Fire sensor;

Z) Oscillation sensor;

AA) Torque sensor;

BB) Piezoelectric sensor;

CC) Strain gauge sensor;

DD) Level sensor;

EE) Proximity sensor; and

FF) Touch sensor.

In an embodiment, remote monitoring system 100 is formed of components designed to withstand the industrial temperature range of minus −40° C. to 85° C.

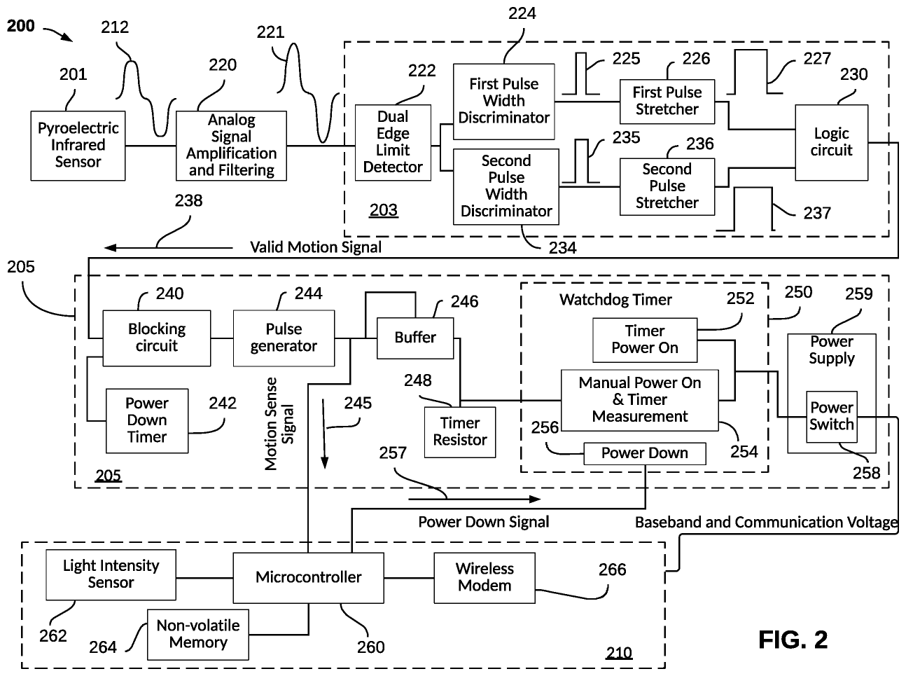

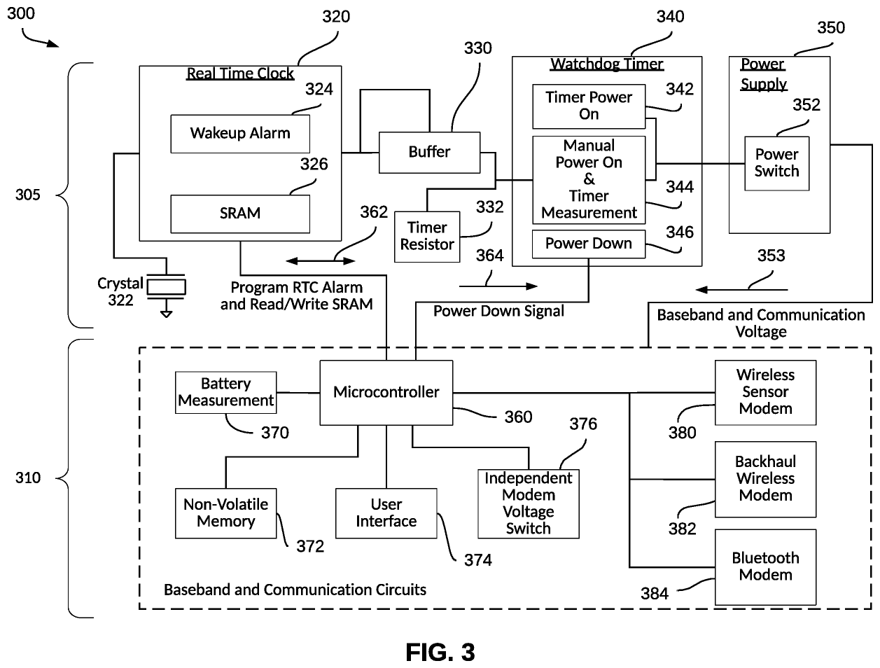

A key feature of remote monitoring system 100 is the extremely low power operation capability. Further details of the circuitry that enables such low power operation are illustrated in FIGS. 2 and 3.

Turning now to FIG. 2, a sensor system 200 including a false detect, discriminator circuit for use with a remote monitoring system, such as remote monitoring system 100 of FIG. 1, in an embodiment, is described. Sensor system 200 includes a PIR sensor 201, and also includes a discriminator logic circuit 203 for determining the validity of a signal received from PIR sensor 201, a timer circuit 205, and a baseband and communication circuits 210, which include a power cycled processor and transceiver circuitry, as will be described in more detail immediately hereinafter,

Continuing to refer to FIG. 2, PIR sensor 201, when triggered, generates a detection signal 212, including one or more positive and negative pulses. An optional analog signal amplification and filtering block 220 then filters and amplifies detection signal 212 to generate a clean, amplified signal 221, which is directed into discriminator logic circuit 203. Discriminator logic circuit 203 filters fast pulses, stretches pulse lengths, and correlates them so as to validate that the stretched positive going pulse and the stretched negative going pulse from PIR sensor 201 overlap, thus confirming validity of the received signal as a detection event.

In an example, clean amplified signal 221, which includes one or more positive and negative signal pulses, is processed by a dual edge limit detector 222 in discriminator logic circuit 203. Dual edge limit detector 222 serves as a “window” detector, to identify and separate the positive and negative pulses within clean, amplified signal 221. Discriminator logic circuit 203 further includes a first pulse width discriminator 224, which is configured to find a high-side edge of a clean signal 221 (i.e., positive going pulse) and convert the high-side edge into a first digital pulse 225. A first pulse stretcher 226 then stretches first digital pulse 225 into a first wide pulse 227, which is fed into a logic circuit 230. Discriminator logic circuit 203 also includes a second pulse width discriminator 234, which is configured to find a low-side edge of clean, amplified signal 221 and convert the low-side edge into a second digital pulse 235. A second pulse stretcher 236 then stretches second digital pulse 235 into a second wide pulse 237, which is also fed into logic circuit 230.

In other words, first and second pulse stretchers 226 and 236, respectively, further stretch first and second narrow pulses 225 and 235, respectively. Logic circuit 230 then validates that the stretched, first and second wide pulses 227 and 237, respectively, overlap, thus ensuring both polarity (i.e., positive and negative) of pulses exist adjacent to each other in time within a specified time period. In particular, first and second width discriminators 224 and 234, respectively, reject stray fast pulses from unintended infrared sources that can cause PIR sensor 201 to generate a false motion detection signal, which would be indicated by the absence of either first wide pulse 227 or second wide pulse 237 at logic circuit 230. As overlap of first wide pulse 227 and second wide pulse 237 is an indication of a true motion detection occurrence from an infrared emitting source traveling across the PIR sensor's field of vision, logic circuit 230 verifies whether or not clean, amplified signal 221, and thus detection signal 212, is indicative of a true motion detection event. Consequently, if first and second wide pulses 227 and 237, respectively, overlap at logic circuit 230, thus indicating that first and second narrow pulses 225 and 235 have occurred within a specified time period, then detection signal 212 indicates an actual motion detection by PIR sensor 201. If only one or neither of first and second wide pulses 227 and 237, respectively, is received at logic circuit 230, detection signal 212 is a false motion detection event and, consequently, rejected by logic circuit 230.

When a true motion event detection is validated at logic circuit 230, a valid motion signal (indicated by an arrow 238) is sent to timer circuit 205. Timer circuit 205 is essentially a combination of first power gating circuit 116 and first wakeup timer 118 in FIG. 1. Initially, valid motion signal 238 enters a blocking circuit 240, which blocks the motion signal while baseband and communication circuits 210 is being powered down to prevent self-generated voltage spikes from causing false triggers on PIR sensor 201. A power down time 242 tracks the amount of time that has elapsed since baseband and communication circuits 210 had been instructed to power down. In this way, blocking circuit 240 provides another protection from false event detection, as PIR sensor 201 shares a common voltage source with baseband and communication circuits 210, which can cause spiking on the voltage source when they are being powered down. The false triggers can be caused, for example, by voltage glitches during power down of baseband and wireless circuits 210.

Continuing to refer to FIG. 2, if valid motion signal 238 is not blocked by blocking circuit 240, a pulse generator 244 generates a motion sense signal (indicated by an arrow 245) to baseband and communications circuits 210. A portion of the pulse generated by pulse generator 244 is also directed via a buffer 246 and a timer resistor 248 toward a watchdog timer 250. Buffer 246 is impedance controlled so as to allow timer resistor 248 to be measured by watchdog timer 250 when buffer 330 is powered down, thus presenting a high impedance to timer resistor 248. Consequently, watchdog timer 250 can measure the watchdog time, which is set by timer resistor 248.

Watchdog timer 250 includes a “Timer Power On” block 452, a “Manual Power On” block 254, and a “Power Down” block 256. Watchdog timer 250 can be set to turn on baseband and communication circuits 210 at preset intervals by triggering a power switch 258 of a power supply 259 via “Timer Power On” block 252. Alternatively, when blocking circuit 240 triggers pulse generator 244 upon reception of valid motion signal 238, the pulse from pulse generator 244 activates “Manual On” block 254 of watchdog timer 250, which in turn triggers power switch 258 to turn on baseband circuit 210. A microcontroller 260 in baseband and communications circuits 210 then receives motion sense signal 245 as a valid motion signal, not related to a routine “Timer Power On” event from watchdog timer 250.

Microcontroller 260, when activated, takes into account light measurements from an optional light intensity sensor 262. Optional light intensity sensor 262 serves as an additional mechanism to determine whether a valid motion detection event has occurred by measuring the ambient light intensity and if, for example, the system is in bright sunlight, then microcontroller 260 can be set to ignore motion sense signal 245. Non-volatile memory 264 records the instances of microcontroller activation as well as other data related to the operation of discriminator logic circuit 203, such as system performance, detected motion detection, as well as factory configuration data. Finally, a wireless modem 266 communicates the microcontroller data with an external hub or other devices, to be discussed in more detail hereinafter. In an embodiment, discriminator logic circuit 203 and timer circuit 205 are always powered on, while baseband and communications circuits are power cycled via power switch 258 in order to reduce the overall system power consumption.

Turning now to FIG. 3, a hub 300, including low power timing circuitry, is described. Hub 300 includes timer circuits 305 and baseband and communications circuits 310. Timer circuits 305 includes circuitry components that are always on, and baseband and communication circuits 310 include circuitry that are power cycled for reduced power consumption.

Timer circuit 305 is essentially a combination of second power gating circuit 156 and second wakeup timer 158 of FIG. 1. In timer circuit 305, a real time clock (RTC) 320 is connected with a crystal 322 such that RTC 320 provides the real time (as opposed to relatively measured time from another time source, such is the case with timer circuit 205 of sensor system 200 in FIG. 2). Timer circuit 305 includes a wakeup alarm 324, which activates baseband and communication circuits at preset time intervals. RTC clock 320 also includes a static random access memory (SRAM) 326, at which the settings for wakeup alarm 324 as well as other activities of hub 300 are recorded. SRAM 326 also stores data while baseband and communication circuits 310 are being power cycled.

Real time clock 320 is connected with a buffer 330, which is impedance controlled so as to allow a timer resistor 332 to be measured by a watchdog timer 340 when buffer 330 is powered down. That is, when buffer 330 is powered down, it presents a high impedance to timer resistor 332, such that a watchdog timer 340 can measure the watchdog time, which is set by timer resistor 332. If real time clock 320 does not wake up, then watchdog timer 340 will take over and force the system to wake up at preset times via an internal timer by a “Timer Power On” block 342. In this way, watchdog timer 340 is available as a fail-safe if, for example, the alarms were not set properly before going into low power mode.

Watchdog timer 340 also includes a “Manual Power On” block 344, which is connected with buffer 330 and timer resistor 332, as well as a “Power Down” block 346. “Timer Power On” block 342 and “Manual Power On” block 344 are connected with a power supply 350, which includes a power switch 352. Power supply 350 is a dedicated power supply that supplies a voltage to baseband and communication circuits 310 and power switch 352 turns on and off the voltage to baseband and communication circuits 310 by the signal from watchdog timer 340.

As shown in the illustrated example, watchdog timer 340 communicates with power supply 350 to turn on or shut down the power to baseband and communication circuits 310. Instructions to turn on the power are activated by a preset timer setting via “Timer Power On” block 342, or on an ad hoc basis by “Manual Power On” block 344, which causes power supply 350 to send a baseband and communication voltage (indicated by an arrow 353) to baseband and communication circuits 310.

Baseband and communication circuits 310 also includes a microcontroller 360, which is configured for analyzing data received from sensor system 200 and sends a power down signal (indicated by an arrow 364) to “Power Down” block 346 upon completion of the various processes at baseband and communication circuits 310 and when baseband and communication circuits 310 is ready to go back to low power mode.

An important role of watchdog timer 340 is to act as a backup timer to mitigate any potential issues with programming of real time clock 320 and to add redundancy to the overall system. The high impedance buffer interface, provided by buffer 330 and timer resistor 332, allows both pre-programmed (i.e., timer) and manual turn on of watchdog timer 340, such that alarms can be programmed during activation of microcontroller 360 for the next turn on event. Watchdog timer 340 is available as a fail-safe if, for example, the alarms were not set properly before going into low power mode.

Continuing to refer to FIG. 3, microcontroller 360 is connected with real time clock 320 and watchdog timer 340. Microcontroller 360 is used for initially programming wakeup alarm 324, as well as to write to and read from SRAM 326 when baseband and communication circuits 310 is powered up, as indicated by a double-headed arrow 362. Furthermore, as discussed, above, microcontroller 360 provides a power down signal 364 to “Power Down” block 346 to indicate when baseband and communication circuits 310 is ready to be powered down.

Microcontroller 360 further controls other power cycled components within baseband and communication circuits 310, such as a battery measurement circuit 370, non-volatile memory 372, user interface 374, and an independent modem voltage switch 376. Battery measurement circuit 370 measures the voltage of voltage sources used within hub 300, such as power supply 350 or an external battery (not shown). Non-volatile memory 372 stores information programmed at the factory, such as hub setting information, as well as data collected by the hub user. User interface 374 can include, for instance, buttons and light indicators (such as light emitting diodes) that allow the user to change the settings for hub 300, such as selecting the power mode, turning certain communication components (such as Bluetooth) on or off, getting the link status on a cellular modem, and linking to sensor systems. Microcontroller 360 also controls one or more modems for transmitting data to an outside location, and processes data that is received and sent by these modems. In an example, independent modem voltage switch 376, through microcontroller 360, is used to ensure that only one of the modems is powered up at any given time. Having only one modem activated at any given time can be important in applications where compliance with Federal Communications Commission (FCC) regulations is required, as FCC regulations prohibit co-location of multiple modems transmitting at the same time without extensive and costly testing. In the example shown in FIG. 3, baseband and communication circuits 310 includes a wireless sensor modem 380, a backhaul wireless modem 382, and a Bluetooth modem 384. Wireless sensor modem 380, in an example, is configured for communicating with sensor systems that are connected with hub 300. Backhaul wireless modem 382 can be, for instance, a low power, cellular modem such as over the LTE M1 network which, when combined with a highly consolidated data packet structure provided by microcontroller 360, enables very low volume communication. Backhaul wireless modem 382 can also be configured for sending data to the cloud for further processing, as well as to receive configuration data from the cloud. Bluetooth modem 384 can be, for instance, configured for local connectivity to Bluetooth-based sensors, as well as to allow the user to interface the hub directly with another Bluetooth device, such as mobile communication devices. Other backhaul modem types, such as LoRA, Sigfox, satellite, and radio modems, can also be included within baseband and communication circuits 310. Additional key features of baseband and communication circuits 310 are 1) these baseband and wireless circuits are programmed to be power cycled; and 2) the power to the wireless modems are independently controlled by microcontroller 360, thus reducing the power consumption by these modems. Also, since the highly consolidated data packet structure enables the use of narrowband modems, the power consumption is reduced. Moreover, the use of 900 MHz links enables communication over a longer range than Bluetooth links.

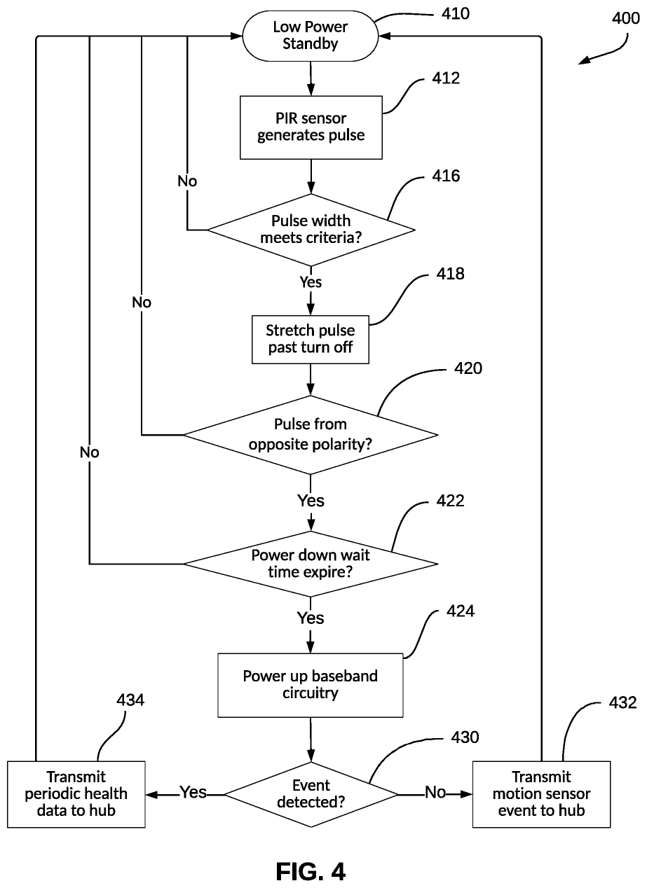

Turning now to FIG. 4, a process for discriminating against false detection, such as by discriminator logic circuit 203, is illustrated. A process 400 begins with a low power standby 410, in which discriminator logic circuit 203 is in a low power standby mode. When a sensor (such as PIR sensor 201) is triggered, the sensor generates a signal pulse in a step 412. A decision is made in a decision 416 to determine whether the pulse width of the signal pulse meets required criteria to be indicative of a valid detection event. For example, first and second pulse width discriminators 224 and 234, respectively, can be used to perform this determination. If the answer to decision 416 is NO, the pulse width of the signal pulse does not meet the required criteria, then process 400 returns to low power standby 410. If the pulse does meet the required criteria and the answer to decision 416 is YES, then the pulse is stretched past turn-off in a step 418, such as using first and second pulse stretchers 226 and 236, respectively.

Continuing to refer to FIG. 4, after pulse stretching step 418, a determination is made whether pulses from opposite polarity were received within a prescribed time frame in a decision 420. Decision 420 can be performed, for example, at logic circuit 230, which receives the stretched pulses from first and second pulse stretchers 226 and 236. If the answer to decision 420 is NO, then process 400 returns to low power standby 410. If the answer to decision 420 is YES, then a decision 422 is made to determine whether any part of the validation circuitry, such as timer circuit 205 or baseband and communication circuits 210 had recently or currently is in a power down process. In particular, decision 422 determines whether a certain wait time following a power down process has expired. The reason for decision 422 is to discriminate against potential false event indications due to voltage spikes from the power down process. If the answer to decision 422 is NO, the power down wait time has not expired, then process 400 returns to low power standby 410. If the answer to decision 420 is YES, then process 400 proceeds to a step 424, in which the baseband circuits (such as baseband and communication circuits 210) are turned on. Then, in a decision 430, a final determination is made whether an actual event was detected. Decision 430 takes into account, for example, measurement by a light intensity sensor incorporated into baseband and communication circuits 210. If the answer to decision 430 is YES, then information regarding the detected event is transmitted to the hub in a step 432. Information regarding the detected event can include, for example, event timestamp and the false detect discriminator outcome. If the answer to decision 430 is NO, the received signal corresponded to a false detection, then the baseband and communication circuits is used to transmit periodic health information regarding the discriminator logic circuit to an external hub in a step 434. The periodic health information can include, for example, false detect discriminator process outcome and other information related to the discriminator logic circuit.

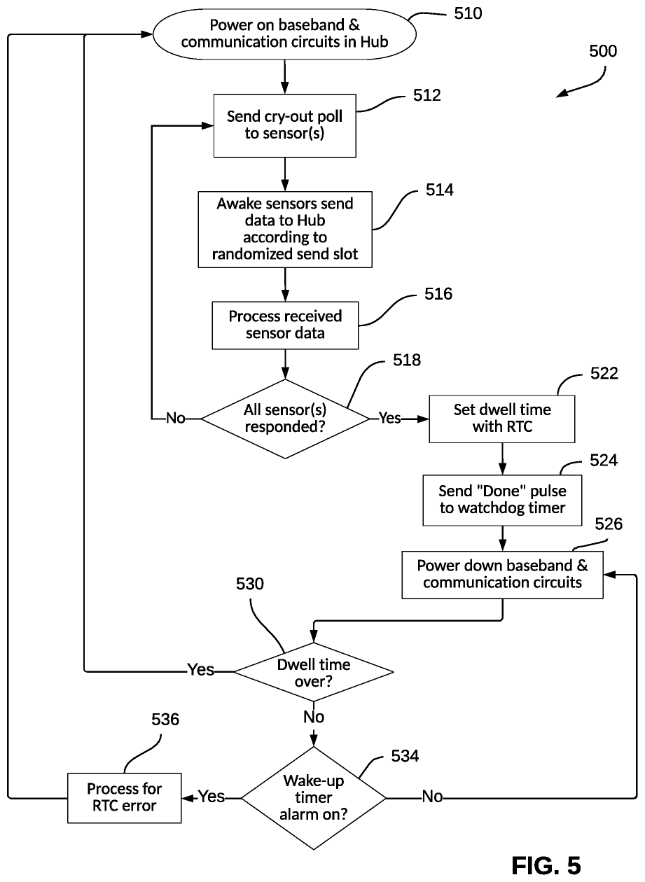

A process for gathering and analyzing data at a hub, such as hub 300 of FIG. 3, is illustrated in FIG. 5. FIG. 5 shows a process 500, which begins when baseband and communication circuits of the hub (e.g., hub 300) is powered on by, for instance, activation of power switch 352. The microcontroller of the hub (e.g., microcontroller 360) then sends a cry-out poll to sensor systems connected therewith in a step 512. The cry-out poll can be transmitted, for example, from one of the communication mechanisms included within baseband and communication circuits 310, such as wireless sensor modem 380. In an exemplary embodiment, the microcontroller regulating the sensor, such as microcontroller 260 in FIG. 2, upon receiving the cry-out poll from the hub, generates a random time offset to determine when that particular sensor should send data. If there are multiple sensors, the sensor with the shortest time offset sends data first in a step 514, while other sensors will await their turn or the next cry-out poll. The data received from the sensor with the shortest random time offset are processed at, for instance, microcontroller 360 in a step 516. A decision 518 is made whether all of the sensors connected with the hub have responded to the cry-out poll. If the answer to decision 518 is NO, then the process reverts to step 512 to await data from other sensors that have not yet responded.

If the answer to decision 518 is YES, then microcontroller 360 communicates with real time clock 320 to set a dwell time in a step 522. Dwell time is defined as the time period during which baseband and communication circuits are powered down, and dwell time should be shorter than the time intervals set at watchdog timer 340 to periodically wake up baseband and communication voltage with Timer Power On block 342.

Once dwell time has been set with the real time clock, microcontroller 360 sends a “Done” pulse to watchdog timer 340 in a step 524, then the baseband and communication circuits are powered down in a step 526. Then a decision 530 is made to determine whether the most recently set dwell time has passed so that, upon expiration of the specified dwell time, real time clock 320 sends a pulse toward watchdog timer 340 so as to activate Manual Power On & Timer Measurement block 344 and power on baseband and communication circuits 310 again at step 510. If the dwell time is not yet over, a decision 534 is made as to whether the wake-up timer alarm at watchdog timer 342 has been activated. If the answer to decision 536 is NO, then the baseband and communication circuits are kept powered down until the expiration of the dwell time. If the answer to decision 536 is YES, then there is a possibility of error, such as the dwell time was set to be longer than the periodic wakeup period set at the watchdog timer. In this case, the process proceeds to a step 536 to process for potential real time clock error, then the process returns to step 510.

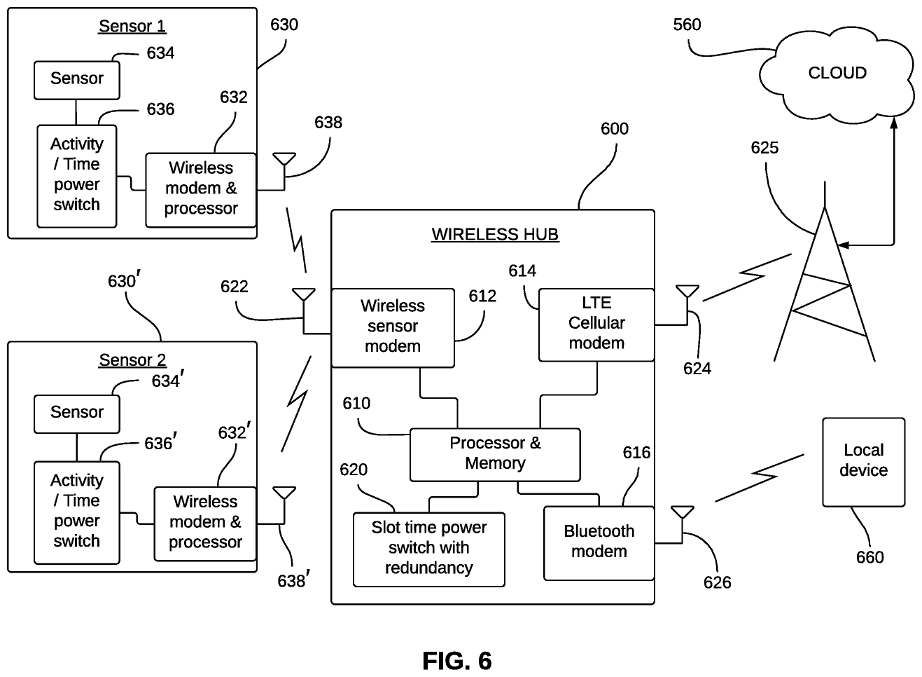

Another exemplary embodiment of a remote monitoring system is shown in FIG. 6. A wireless hub 600 includes many of the features of hub 300 of FIG. 3, such as a processor and memory block 610, a wireless sensor modem 612, an LTE cellular modem 614, a Bluetooth modem, and a slot time power switch 620 with redundancy. Processor and memory block 610 controls the power management aspects of wireless hub 600. Wireless sensor modem 612 is connected with a wireless antenna 622 for communicating with external sensors. LTE cellular modem includes a cellular antenna 624, which is configured for communicating with a cell tower 625 to Internet cloud 560. Bluetooth modem 626 is connected with a Bluetooth antenna 626 for communicating with a local device 627, such as a smart phone, laptop, or other Bluetooth-enabled device.

Continuing to refer to FIG. 6, wireless hub 600 is configured for communicating with multiple sensors 630, 630′, and so on. Each one of sensors 630 includes a wireless modem and processor block 632, which controls a sensor 634 (e.g., a PIR sensor or others listed above) and an activity/time power switch 636, which can be turned on or off manually or on a timer, as previously discussed relative to power switch 258. Data from multiple types of sensors, such as a PIR sensor, a temperature sensor, a pressure sensor, and others, can all be fed into wireless hub 600 to provide remote monitoring of multiple data inputs.

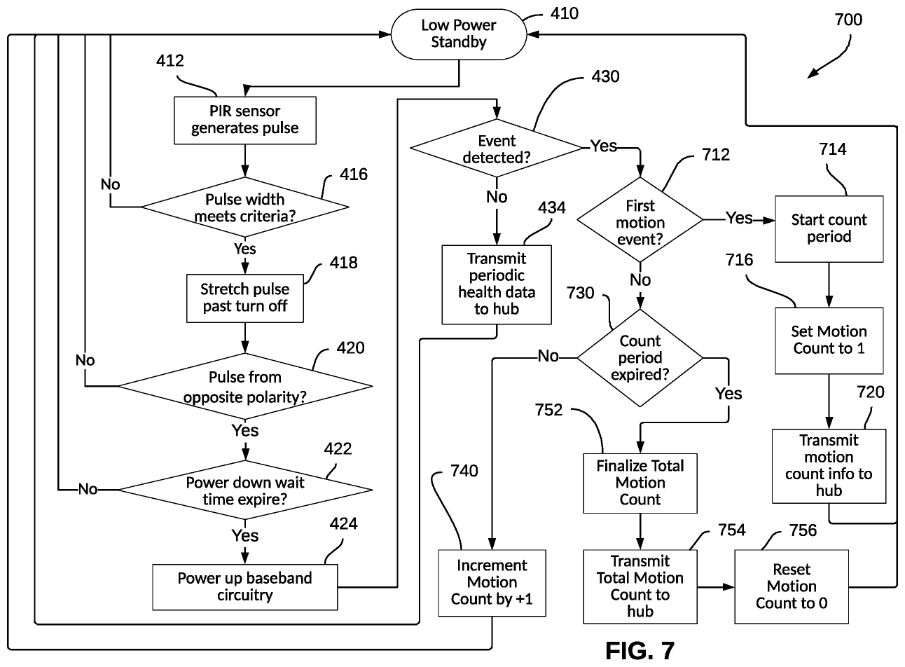

In another embodiment, remote monitoring system 100 of FIG. 1 can also be used to identify specific types of activity being counted by the system. An example process is illustrated in FIG. 7, which shows an extended version of the flow chart of FIG. 4. A process 700 further includes a motion counting process, which can be used to identify specific types of activity detected by the system.

Continuing to refer to FIG. 7, process 700 picks up from decision 430, in which a determination is made whether a true motion event has been detected. If the answer to decision 430 is YES a motion event has been detected then, before the determination is transmitted to the hub, a decision 712 is made to determine whether the detected event is a first motion event detected outside of a preset count period. As an example, the detection of a first motion events starts the motion count at 1 and initiates a preset count period, which can be 20 minutes or another time interval that has been specified by a user or preset by the system manufacturer. If the answer to decision 712 is YES, the detected event is the first motion event detected outside of the preset count period, then a preset count period is initiated in a step 714, a Motion Count is set to 1 in a step 716, then the motion count information, indicating the receipt of a first motion event, is sent to the hub as motion count information in a step 720.

If the answer to decision 712 is NO, the preset count period has already been initiated and the detected event is not the first motion event within the preset count period, then process 700 proceeds to a decision 730 to determine whether the preset count period has expired. For example, if the detected event is a second detected event received five minutes after the detection of a first motion event, and the preset count period is twenty minutes, then the answer to decision 730 is NO. If the answer to decision 730 is NO, the count period has not expired, then the Motion Count is incremented by +1 in a step 740, and the system returns to low power standby status 410.

If the answer to decision 730 is YES, the count period is expired, then a Total Motion Count, defined as the total number of events counted within the previous count period, is finalized in a step 752, and the Total Motion Count is transmitted to the hub as motion count info in a step 754, and the Motion Count is reset to zero in a step 756. The system then returns to low power standby status 410. The Total Motion Count information can be interpreted by the system or the user to discriminate between different types of activity detected by the system. For instance, when the system is used on a mouse trap, the system can be used to count the number of passes made by a moving object across the field of view of the sensor. In this case, a high Total Motion Count within a preset count period can be interpreted as an indication that one or more animals have been caught within the mouse trap. Similarly, a low Total Motion Count for a mouse trap can be an indication of a person or an animal walking by the trap, or some temperature or atmospheric anomaly, further reducing the possibility of false detects.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. For example, the various data processing components, such as processing circuits in the hub as well as discriminator logic circuits in the sensor system and computing systems in the cloud, can incorporate artificial intelligence learning in order to improve the accuracy of event detection and recording capabilities. As shown in FIG. 2, the sensor system can optionally include a light intensity sensor in order to collect data regarding the lighting conditions to be taken into consideration in the data analysis. Other features, such as a global positioning system (GPS) and/or location detection via cellular towers, can be incorporated into the sensor system in order to provide location information. The hub and/or the sensor system can be powered by one or more batteries or by plug-in connection to a wall outlet, 12V outlet, or another appropriate power source. Due to the low power consumption and high bandwidth capabilities of the described remote monitoring system, the system can be used as a platform for other applications for backhauling data from a variety of hardware, such as temperature tracking, tire pressure monitoring for RVs, and others.

Accordingly, many different embodiments stem from the above description and the drawings. It will be understood that it would be unduly repetitious and obfuscating to literally describe and illustrate every combination and subcombination of these embodiments. As such, the present specification, including the drawings, shall be construed to constitute a complete written description of all combinations and subcombinations of the embodiments described herein, and of the manner and process of making and using them, and shall support claims to any such combination or subcombination.

In the specification, there have been disclosed embodiments of the invention and, although specific terms are employed, they are used in a generic and descriptive sense only and not for purposes of limitation. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A low power, remote monitoring system comprising:
a hub system in communication with a sensor system,
wherein the hub system includes
a real time clock for generating an RTC signal upon passage of a preset dwell time,
a first power gating circuit for generating a first power-on signal in response to receiving the RTC signal, and
a first baseband and communication block configured for
activating when the first power-on signal is received,
when activated, sending a cry-out poll to the sensor system for data related to an event detection,
once data has been received from the sensor system, specifying the preset dwell time at the real time clock, and
sending a first power-down signal to the first power gating circuit,
wherein the sensor system includes
a sensing circuit for generating a sensing signal when an event is detected,
a discriminator logic circuit for receiving the sensing signal, validating the sensing signal, and generating a valid motion signal only if the sensing signal corresponds to a validated event,
a second power gating circuit for generating a power-on signal in response to the valid motion signal received from the discriminator logic circuit, and
a second baseband and communication block configured for
activating when the power-on signal is received from the second power management circuit,
generating an event detection signal as data related to the event detection,
transmitting the event detection signal to the hub system when the cry-out poll is received, and
sending a second power-down signal to the second power gating circuit, once the event detection signal has been transmitted to the hub system,
wherein the first and second power gating circuits are configured to power down the first and second baseband and communication blocks upon receipt of the first and second power-down signals, respectively.

2. The low power, remote monitoring system of claim 1, wherein the hub system further includes a first wake-up timer for generating a first wake-up signal at preset time intervals,
wherein the first power gating circuit is configured for generating the first power-on signal in response to one of the valid motion signal and the first wake-up signal.

3. The low power, remote monitoring system of claim 2, wherein the preset time intervals is longer than the preset dwell time.

4. The low power, remote monitoring system of claim 2, wherein the sensor system further includes a second wake-up timer for generating wake-up signals at preset time intervals,
wherein the second power gating circuit is configured for generating the second power-on signal in response to one of the RTC signal and the second wake-up signal.

5. The low power, remote monitoring system of claim 2, wherein the sensor system is configured for providing a system status signal rather than the event detection signal, if no validated event had occurred when the cry-out poll is received.

6. The low power, remote monitoring system of claim 1, wherein the discriminator logic circuit is further configured for counting the number of valid motion signals generated within a preset count period to generate a total motion count received within the preset count period.

7. The low power, remote monitoring system of claim 6, wherein the discriminator log circuit is further configured for determining a type of event detected using the total motion count.

8. A method for remotely detecting a motion event using a hub system in communication with a sensor system, the hub system and the sensor system including a first and a second baseband and communication blocks, respectively, the method comprising:
generally maintaining the first and second baseband communication blocks in a power-down state;
powering on the first baseband and communication block in the hub system at preset time intervals;
using the first baseband and communication block to send a cry-out poll to the sensor system at the preset time intervals;
if an event is detected at the sensor system prior to the receipt of the cry-out poll, then
generating a sensing signal,
validating the sensing signal,
generating a valid motion signal, only if the sensing signal corresponds to a validated event,
powering on the second baseband and communication block,
transmitting an event detection signal from the second baseband and communication block to the first baseband and communication block, and
powering down the first and second baseband and communication blocks after the event detection signal has been received at the hub system using the first baseband and communication block.

9. The method of claim 8, wherein, if no event has been detected at the sensor system prior to the receipt of the cry-out poll, then
powering on the second baseband and communication block,
transmitting a system status signal, rather than the event detection signal, from the second baseband and communication block to the first baseband and communication block, and
powering down the first and second baseband and communication blocks after the system status signal has been received at the hub system using the first baseband and communication block.
